(19) United States
(12) Patent Application Publication
(10) Pub. No.: US 2010/0089244 A1
(43) Pub. Date: Apr. 15, 2010

(54) Electric beverage making machine comprising a control unit

(75) Inventor: Christof Zwahlen, Walzenhausen (CH)

Correspondence Address: Quinn Emanuel Urquhart Oliver & Hedges, LLP;Koda/Androlia, 10th Floor, 865 S. Figueroa Street, Los Angeles, CA, 90017, US

(73) Assignee: Eugster/Frismag AG

(21) Appl. No.: 12/587,920

(22) Filed: Oct. 14, 2009

(30) Foreign Application Priority Data
Oct. 15, 2008 (DE) 20 2008 013 555 9

(51) Int. Cl. A23L 1/00

(52) U.S. Cl. 99/275

(57) ABSTRACT

An electric beverage making machine including a control unit and at least one electric function unit for a process of making the beverage. For the power supply to the function unit and to the control unit, a first switching contact having an actuation element and a power supply are provided in a power supply circuit. Parallel to the first switching contact, a second switching contact is provided which is actuated by the control unit. The first switching contact is a two-way contact having a power supply contact and a control contact which is connected with an input of the control unit and can alternatingly make contact with the power supply contact.

### BACKGROUND OF THE INVENTION

The present invention relates to an electric beverage making machine comprising a control unit.

Electric beverage making machines of this kind can be designed for making coffee and/or espresso and/or steam and/or hot water and/or hot milk and/or frothed milk to which end one, or a plurality of, function units of the beverage making machine are required.

For practical reasons, the electric beverage making machines are mostly constantly connected by a plug with the mains supply to be constantly ready for service as far as the electric energy supply is concerned. On the other hand, beverage making machines unless switched on for the making, or making available of, beverages should not, if possible, use energy from the mains supply. For cases of a voluntary switching off of the beverage making machine by an operator, it should be avoided that breakdowns or, in extreme cases damages, of the beverage making machine will come up in that it will be switched off during a phase of operation unsuited for switch-off.

In order to reach these goals, a beverage making machine has already been known (EP 1 854 386 A1) comprising an electrically operable control unit, at least one electrically operable function unit for performing at least one process which takes part in the making, or making available, respectively, of the beverage, wherein the control unit is connected in a signal or data transferring manner with at least one function unit, and includes a power supply circuit for the power supply to the function unit and the control unit, in which a first switching contact and a second switching contact are connected in parallel. An actuation element, particularly a manually operable actuation key, cooperates with the first switching contact particularly in such a way that by a first actuation of the actuating element, it is in a closed state and after a second actuation of the actuating element it is in an open state. In contrast thereto, the second switching contact is controlled by the control unit by means of a control signal to either take a closed or an open state. Together with the control unit, detection means for detecting an actuation of the actuation element of the first switching contact cooperate so that the actuation sequence is recorded by the control unit. The control unit is so designed that it emits, after a first actuation of the actuation element, a control signal which puts the second switching contact into the closed state or, after recording a second actuation of the actuation element generates a control signal by which the second switching contact is opened, provided that corresponding to a signal of the function unit to the control unit the function unit is ready for switch-off or, provided that a predetermined time delay has passed which is recorded by the control unit as well. The second switching contact is, in particular, a closing contact of a relay. The first switching contact may be a pulse switching contact or a permanent switching contact. The detection means may comprise a third switching contact which when actuating the actuation element passes from an open state into a closed state, or vice versa. Instead of the third switching contact, a sensor may be provided. In each of these concrete cases, the realization of the detection means galvanically separated from the first switching contact, particularly the third switching contact, requires considerable additional sophisticated means.

### SUMMARY OF THE INVENTION

The present invention is, therefore, based on the task to reduce costly sophisticated means for detection in a beverage making machine of the kind referred to in the beginning to reach the goals mentioned above while retaining, in particular, the reliable switch-off function.

This task is solved for an electric beverage making machine with the features of the present invention wherein an electric beverage making machine comprises a control unit (7), at least one electric function unit (8) for performing at least one process which takes part in the making of the beverage, said control unit (7) being connected with at least one function unit (8) in a signal-transferring manner, a power supply circuit (3, 4) for the power supply to said function unit (8) and said control unit (7), in which a first switching contact (5) actuated by an actuation element (10) having a power supply contact (11) which is connected with said power supply circuit (3, 4), and parallel to said first switching contact (5) a second switching contact (6) is provided which is actuated by said control unit (7), wherein detecting means actuated by key (10) are connected in a signal-transferring manner with said control unit (7); and in this electric beverage making machine, said first switching contact (5) is a two-way contact having said power supply contact (11) and a control contact (12) which can alternatingly make contact with said power supply contact (11) and which constitutes a detecting element of said detecting means connected with the input of said control unit (7).

In the detecting means, therefore, an additional control element galvanically separated from the first switching contact can be dispensed with, particularly a third switching contact which, together with the first switching contact, can be operated, i.e. switched, by an actuation element, or a corresponding sensor. Rather, it is sufficient if the first switching contact, as a two-way contact, is provided not only with the power supply contact which is electrically connected with the power supply circuit in order to take over, on a first actuation of the actuation element, an initial power supply of the control unit and of the function unit, but also with a further fixed contact, i.e. the control contact which constitutes the detection element of the detection means recording the actuation of the actuation element and which is connected to an input of the control unit. The contacting of the control contact decisive for the detection of the actuation of the actuation element is necessarily guaranteed by the formation of the first switching contact as a two-way contact in that the control contact is alternately, i.e. conversely relative to the power supply contact, contacted, or not contacted, respectively, by the first switching contact.

A further simplification may be reached in that a switch the constituent of which is the first switching contact and which may be actuated by the actuation element, need not be designed in such a way that the first switching contact will, on a first actuation of the actuation element, functions differently from a second actuation, particularly if closed on a first actuation and opened on a second actuation. Rather, the first switching contact may be effective in the same way on each actuation of the actuation element in that it is designed as a two-way key contact so that, if the actuation element is not actuated, it contacts the control contact, and does not contact the power supply contact which is connected to the electric circuit, preferably to a non-disconnectible branch of the circuit for the power supply, while, if the actuation element is actuated, it does contact for a short time the power supply contact and does not, correspondingly, contact the control contact. Under “short time” one can particularly understand an interval of at least 200 milliseconds to switch the power supply on and an interval of at least 100 milliseconds to switch it off.

For short-time contacting of the power supply contact of the first switching contact, it is designed as a key contact.

In the present invention, the detecting means and the control unit connected therewith in a signal-transferring manner are suited, as generally known, to record in the control unit an actuation sequence of the actuation element. Based upon the above, the control unit shall generate each time after recording a first one of two successive actuations a control signal by which the second switching contact is closed which, therefore, will take over the power supply. On the other hand, each time after recording a second of two successive actuations and depending on the function state of the at least one function unit and/or timely delayed, for instance about a fixed time interval, the control unit shall generate a control signal by which the second switching contact is opened and power supply is switched off. The above-mentioned delay interval may also be determined depending on the operating condition of the beverage making machine at the time of actuating the actuation element.

In the present invention, the second switching contact may, as known per se, be the closing contact of a relay.

In the present invention, a relay coil of the relay electrically connected, via a control line and, if required, via a controlled switch, with an output of the control unit so that the relay coil is connected via the controlled switch with the power supply and will be energized.

In the present invention, the second switching contact may alternatively be a semiconductor switch which is controlled via a control line by the control signal from the control unit so that the disconnectible branch of the power supply circuit is connected, via the controlled switch, with the non-disconnectible part of the power supply circuit, or the mains supply.

In each case, the second switching contact is not directly opened nor closed by actuating the actuation element but rather after processing the actuation detected by the detecting means and not before the evaluation of a corresponding confirmation signal in the control unit.

In the present invention, the control unit is suitably a main control unit (MCU) by which not only the power supply of the beverage making machine as a whole is controlled but, individually, the respective functions to be performed each time in the at least one electric function unit as well.

Since the beverage making machine inclusive of the control unit which controls the on and off switching processes after each switch-off is completely separated from the power supply grid in order to save energy, the beverage making machine of the present invention is suitably expanded, by an accumulator unit which feeds the control unit and a real time clock prior to a first actuation of the actuation element alternatively to the power supply grid. In this case, the control unit is suited to cooperate with the real time clock so that the beverage making machine is automatically started by the control unit and the real time clock at a predetermined time. In this way, it is possible to start the machine, for instance in the morning of a day, without the assistance of an operator.

### BRIEF DESCRIPTION OF THE DRAWINGS

In the following, the invention will further be explained based on a drawing comprising 1 figure from which further developments and details of the invention can be taken.

FIG. 1 shows a schematic circuit diagram of a beverage making machine according to the present invention.

### DETAILED DESCRIPTION OF THE INVENTION

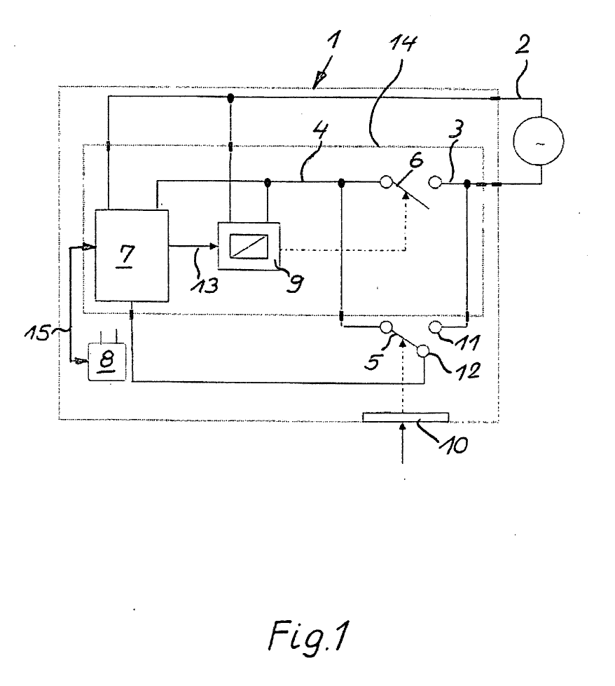

In FIG. 1, reference numeral 1 shows schematically, in a dotted frame, the electric part of a beverage making machine, particularly a coffee or espresso machine which can be connected, via connections, not shown, to an external power supply grid 2.

In the beverage making machine, a power supply circuit having a non-disconnectible branch 3 and a disconnectible branch 4 is provided wherein between the disconnectible branch 4 and the non-disconnectible branch 3 a parallel connection of a first switching contact 5 and a second switching contact 6 is disposed.

The disconnectible branch 4 of the power supply circuit feeds a main control unit 7, at least one function unit 8 and a relay coil including a trigger 9.

In the present exemplified embodiment, the first switching contact 5 designed as a two-way key contact constitutes part of a micro switch having a key 10 by which the first switching contact may manually be actuated. The first switching contact 5 comprises in addition to a movable contact piece, not shown, which is connected in the present embodiment to the disconnectible branch 4 of the power supply circuit, a power supply contact 11 on the non-disconnectible branch 3 of the power supply circuit, which is designed as a key contact in order to close, by actuating key 10, for the period of the actuation, the power supply contact 11, and a control contact 12 arranged as a rest contact which is contacted alternately to the power supply contact 11 with the movable contact piece of the first switching contact 5 if the key is not actuated, or in the rest position of the first switching contact, respectively.

The control contact 12 connected to one input of main control unit 7 constitutes an element of detection means by which an actuation, or an actuation sequence, respectively, of the key 10 is detected and evaluated in the main control unit 7.

The second switching contact 6 is designed as a closing contact of relay coil 9 and like the first switching contact 5 is suited to connect the disconnectible branch 4 of the power supply circuit with the non-disconnectible branch 3. The second switching contact 6 is closed based on a control signal generated in main control unit 7 and is fed via a control line 13, for instance to a controlled switch, not shown in the drawing, which connects relay coil 9 with the disconnectible branch 4 of the power supply circuit.

The structure of main control unit 7 results from the function description further below.

In addition to the main control unit 7 and the relay coil 9 as components of the beverage making machine 1, the latter includes at least one function unit 8 which can also be fed from disconnectible branch 4 of the power supply circuit. The function unit 8, but also a plurality of such function units, may, controlled by the main control unit 7 via a function control line 15, perform individual processes, or functions, respectively, in the preparation of a beverage, such as grinding of coffee, heating of water, brewing of coffee, preparation of steam and auxiliary functions.

In the following function description, one starts from the rest position of the first switching contact 5, shown in FIG. 1, from which a first actuation of an actuation sequence takes place wherein the processes are repeated after each second actuation.

On the first actuation of the key 10, the first switching contact 5 changes its position while it shortly contacts the power supply contact 11 and initially connects the disconnectible branch 4 of the power supply circuit with the non-disconnectible branch 3, or with the power supply grid 2, respectively. At the same time, the first switching contact 5 opens the connection to the control contact 12, whereby an actuation signal appears on the respective input of the main control unit 7 which records the actuation signal as switch-on signal, or first signal of a sequence of signals, respectively, and subsequently makes available a control signal which arrives via the control line 3 to the controlled switch, not shown, which connects the relay coil 9 with the branch 4 of the power supply circuit. The branch 4, in addition, is connected, via the first switching contact 5, with the power supply grid 2. By means of the relay energized by the relay coil 9, the second switching contact 6 is closed and the first switching contact 5 needs no longer remain closed and can take its rest position. The branch 4 remains connected to the non-disconnectible branch 3, or power supply grid 2, respectively, until the next actuation of the key 10. Thereby, the main control unit 7. remains operative and may control the function unit 8.

The function unit 8 may input a signal in the main control unit 7 which signalizes the termination of the respective function and is taken into account in a subsequent switch-off process of the beverage making machine.

In order to switch the beverage making machine off, the key 10 is to be actuated again, i.e. a second time in the actuation sequence, so that the first switching contact 5 leaves again the rest position shown in FIG. 1 and the control contact 12, shortly separated from it, emits a further confirmation signal to the input of the main control unit 7 which can be recorded in the control unit 7 as second confirmation signal. This causes that in the main control unit 7 the control signal on the control line 13 is correspondingly altered so that it effects switch-off of the relay coil 9. Consequently, the second switching contact 6 drops off as relay contact so that the disconnectible branch 4 is separated from the non-disconnectible branch 3, or power supply grid 2, respectively.

This results in that the electronic unit 14 of the beverage making machine which comprises the main control unit 7 and the relay including relay coil 9 is ready for a renewed switch-on process when actuating the key 10.

Furthermore, the electronic unit 14 may be expanded by an accumulator unit, not shown in FIG. 1, from which a real time clock, not shown either, and the control unit 7 are fed if the disconnectible branch 4 of the power supply circuit is separated from power supply grid 2. The beverage making machine 1 may in this way automatically be started by the disconnectible branch 4, completely separated from the non-disconnectible branch 3, or power supply grid 2, in that the real time clock generates a corresponding start signal which is converted in the main control unit 7 into a control signal on the control line 13 so that the relay coil 9 is energized and closes the second switching contact 6 which activates further power supply to the beverage making machine from the power supply grid 2. The main control unit 7 may then again emit function control signals, via the function control line 15, to the function unit 8 by which the desired functions, for instance the preparation of coffee, will automatically be performed.

The accumulator unit may also comprise a charging device which has not been shown in FIG. 1 either.

1. Electric beverage making machine comprising a control unit (7), at least one electric function unit (8) for performing at least one process which takes part in the making of the beverage, said control unit (7) being connected with at least one function unit (8) in a signal-transferring manner, a power supply circuit (3, 4) for the power supply to said function unit (8) and said control unit (7), in which a first switching contact (5) actuated by an actuation element (10) having a power supply contact (11) which is connected with said power supply circuit (3, 4), and parallel to said first switching contact (5) a second switching contact (6) is provided which is actuated by said control unit (7), wherein detecting means actuated by key (10) are connected in a signal-transferring manner with said control unit (7)
characterized in
that said first switching contact (5) is a two-way contact having said power supply contact (11) and a control contact (12) which can alternatingly make contact with said power supply contact (11) and which constitutes a detecting element of said detecting means connected with the input of said control unit (7).

2. Beverage making machine according to claim 1,
characterized in
that said first switching contact (5) to be actuated by said key (10) is a two-way key contact which contacts said control contact (12) when said key (10) is not actuated, and does not contact said power supply contact (11) which is connected to said power supply circuit (3, 4), preferably to a non-disconnectible branch (3) of said power supply circuit, and which contacts said power supply contact (11) when said key (10) is actuated, and does not, correspondingly, contact said control contact (12).

3. Beverage making machine according to claim 2,
characterized in
that said power supply contact (11) of said switching contact (5) is a key contact.

4. Beverage making machine according to claim 1,
characterized in
that said detecting means (12) and said control unit (7) connected therewith in a signal-transferring manner are suited to provide that in said control unit (7) an actuation sequence of said key (10) is recorded,
that said control unit (7), each time after recording a first one of two subsequent actuations, generates a control signal by which said second switching contact (6) is closed, and
that said control unit (7), each time after recording a second one of two subsequent actuations and depending on the function state of said at least one function unit (8) and/or delayed, generates a control signal by which said second switching contact (6) is opened.

5. Beverage making machine according to claim 1,
characterized in
that said second switching contact (6) is the closing contact of a relay.

6. Beverage making machine according to claim 5,
characterized in
that one relay coil (9) of said relay is connected via a control line (13) and, if necessary, via a controlled switch with one output of said control unit (7) and can be energized by said control signal.

7. Beverage making machine according to claim 4,
characterized in
that said second switching contact is a semiconductor switch which can be controlled by said control signal via a control line (13).

8. Beverage making machine according to one of claims 1 to 7,
characterized in
that said control unit (7) is a main control unit (MCU).

9. Beverage making machine according to one of claims 1 to 7,
characterized by
an accumulator unit from which said control unit (7) and a real-time clock are fed prior to a first actuation of said actuation element, as an alternative to the mains supply, and
that said control unit (7) is suited to cooperate with said real time clock so that said beverage making machine (1) is started by said control unit and said real time clock.

10. Beverage making machine according to claim 8,
characterized by
an accumulator unit from which said control unit (7) and a real-time clock are fed prior to a first actuation of said actuation element, as an alternative to the mains supply, and
that said control unit (7) is suited to cooperate with said real time clock so that said beverage making machine (1) is started by said control unit and said real time clock.
